(19) United States
(12) Patent Application Publication
(10) Pub. No.: US 2007/0242090 A1
(43) Pub. Date: Oct. 18, 2007

(54) Apparatus and method for setup frame sequencing in color sequential display systems

(75) Inventor: David A. Struyk, Deephaven, MN (US)

Correspondence Address: SCHROEDER & SIEGFRIED, P.A., 15600 WAYZATA BOULEVARD, SUITE 200, WAYZATA, MN, 55391, US

(73) Assignee: WaterStrike Incorporated

(21) Appl. No.: 11/403,279

(22) Filed: Apr. 13, 2006

(51) Int. Cl. G09G 5/10

(52) U.S. Cl. 345/690

(57) ABSTRACT

A color sequential image display apparatus and method which reduces the effects of display frame crosstalk in the display apparatus by incorporating setup display frames for each color component in the color display sequence, where the display of each sequentially displayed color component is initiated and updated immediately prior to independently viewing the color component through synchronized color-filtering eyewear, thereby avoiding interference from previously viewed color components in the display sequence. The use of such setup frame sequencing has particular application in confidential viewing and three-dimensional viewing systems where sequential color encoding of the image signal is utilized.

### BACKGROUND OF THE INVENTION

The present invention is related generally to the art of sequential color encoding of electronic display images, and is more particularly related to improving the performance of such display systems by reducing display frame crosstalk through the use of color sequencing setup frames. This invention has particular application in such color sequential display systems as may be utilized in confidential viewing applications, and in applications involving three-dimensional image viewing, where subsequent decoding of a fundamental image using specialized eyewear is required for proper intended viewing.

Any such color sequential display system involves encoding or modifying of the fundamental display image at each pixel location of the display so as to display the color components thereof sequentially over time. In other words, it is the object in such a system that at least one color component of the fundamental image at each pixel be always displayed out of time-phase with the remainder of the fundamental image color components at the same display pixel location. Viewing of the fundamental image then involves using synchronized color-filtering eyewear to filter out the appropriate color component at the desired time.

Confidential Viewing

The use of sequential color encoding in a confidential viewing system is perhaps best disclosed in my recently issued U.S. Pat. No. 6,980,177, entitled Sequential Inverse Encoding Apparatus and Method for Providing Confidential Viewing of a Fundamental Display Image, the contents of which are incorporated herein by reference thereto. In such a system, the color components of a fundamental image are time-multiplexed with corresponding masking color components in accordance with a desired sequencing pattern, thereby rendering the fundamental image substantially indecipherable to the naked eye. Ideally, the masking color components are related to the fundamental color components, and preferably the “inverse” thereof, such that the resulting compound image formed by the combination of the fundamental and masking color components is substantially featureless to the naked eye.

Three-dimensional (3D) Viewing

In order to simulate three dimensional viewing, most 3D viewing systems record the image of an object from two different perspectives and utilize a display and specialized eyewear to view the two perspectives separately, one with the right eye and the other with the left. In most systems, Liquid Crystal display (“LCD”) shutter glasses are used to block the left components from the right eye, and the right components from the left eye. The images on the display, which alternate in synchronization with the glasses, are intended for either the right or left eye only. This technique is known as “field sequential” viewing.

Unfortunately, the LCD shutters introduce substantial eye flicker when utilizing the field sequential technique. For this reason, color sequential display systems utilizing sequential color encoding have also been proposed in the past as a way of eliminating such irritating eye flicker. In one such system, as disclosed in U.S. Pat. No. 4,641,178, the color components of each perspective of the image are supplied in alternating sequence and in such a way that while the left eye is receiving one color component of one of the perspectives, the right eye receives the complementary color components of the other perspective, and vice versa.

Color sequential display systems of the kind describe above for use in confidential viewing and 3D viewing systems may be implemented and are quite effective utilizing conventional cathode ray tube (“CRT”) displays, where rapid phosphor decay causes images to vanish quickly once displayed. However, with the newer liquid crystal display (“LCD”), the effectiveness of the color sequential display system is limited somewhat by the performance of current LCD technology. In these systems, when color changing eyewear is used to filter undesirable color components in display frames and allow intended color components to pass, the present state of the art for LCD displays does not allow for fast enough switching of display elements to avoid a phenomenon known as crosstalk. Crosstalk occurs when the content of one display frame interferes with another.

Because LCD displays are designed to be compatible with older CRT technology, they currently utilize traditional vertical timing, where updating of the last row of display pixels occurs immediately before the updating of the top row of pixels in the next display frame. However, the pixel image of an LCD display does not decay as in a conventional CRT, but rather maintains the current voltage state until switched. So, at any instant of time, except for the time between the updating of the last pixel on the last row and the first pixel of the first row, know as the “retrace period”, the display will contain color components of both the current and previous frames. In fact, if the intent is to view the red fundamental color components, and the eyeglasses are switched to red in synchronization with the vertical synch pulse, then the upper rows the viewer sees will be mostly from the current frame, while at least some of the lower rows will be color components primarily from the previous frame.

If the update sequencing was such that the entire display was written to out of memory, rather than from the analog signal, the display could be updated much more quickly. Unfortunately, the response time of the present-day LCD pixel is still too slow. A typical fast LCD display has a response on the order of 8 milliseconds. Assuming a 60 Hz refresh rate, or 16.7 milliseconds per frame, 8 ms is still too long to avoid crosstalk. For approximately ½ of the frame, the viewer will be looking at the wrong pixel images, or pixels in transition. For normal video, this is not a problem as it is not necessary that all the pixels change simultaneously, only quickly to avoid smearing. These are also the primary reasons why 3D displays using LCD shutter glasses are not presently utilized with LCD screens.

From the above, it is evident that there is a distinct need for a means of reducing or eliminating the effects of display frame crosstalk in color sequential display systems, as utilized in such applications as confidential and 3D viewing, so as to improve the overall performance of such systems, as well as their compatibility with present-day LCD technology. It is with this object in mind that I have conceived of my present invention, as will be described in detail hereafter and defined in the appended claims.

### BRIEF SUMMARY OF THE INVENTION

The solution to substantially reducing or eliminating the undesirable effects of display frame crosstalk, and in particular with respect to LCD displays, lies in the fact that the pixels of an LCD display, or more precisely, the red, green and blue sub-pixels of each pixel, do not decay, and in fact do not change at all unless required to do so in the next display frame update. The pixel switches of an active matrix LCD act as memory bits maintaining the current voltage state to the pixel cell until switched. Thus, the specific color component that corresponds to each sub-pixel being energized also will not decay or switch until the voltage level at that pixel cell is changed. This allows for the sequencing of pixel data using “setup frames,” as will be described hereafter.

In the present invention, since it is the object in a sequential color display system to display and view the color components of a desired image sequentially over time, setup frames may be utilized for updating each color component immediately prior to viewing the same. By initiating the update of the display in advance of viewing the next color component, upon switching to the next display frame, the color component (or corresponding sub-pixel) then intended to be viewed will already have been activated at all pixel locations. Updating of the next color to be viewed is accomplished during the next preceding display frame, while the previous color component in the sequence of colors is being viewed. Since the specialized eyewear permits viewing only of a single color component at any given time (one for each eye in 3D applications), the viewer cannot see the color being updated during the setup frame.

If, for example, the viewer is viewing the red color components of an image, and the green color components are the only ones being updated to their next frame, the viewer will see only the intended red color components, not the green. In the next frame, the glasses can very quickly (less than 1 millisecond) change to a green filter to allow viewing of the green color components, and the green sub-pixels would have already changed. While viewing the green sub-pixels, the blue sub-pixels would be updated. In this way, each color component is updated before the color of the glasses is switched, thus substantially reducing or eliminating the effects of display frame crosstalk.

### BRIEF DESCRIPTION OF THE DRAWINGS

These and other objects and advantages of the invention will more fully appear from the following description, made in connection with the accompanying drawings, wherein like reference characters refer to the same or similar parts throughout the several views, and in which:

FIG. 1 is a general block diagram depicting a prior art sequential color display system, wherein a confidential computer viewing system utilizing sequential color encoding techniques to mask and subsequently decode a fundamental image for confidential viewing is shown.

FIG. 2 is a general block diagram depicting a sequential color display system according the present invention, wherein a confidential computer viewing system utilizing sequential color encoding techniques incorporates “setup” frame sequencing to eliminate the effects of display frame crosstalk.

### DETAILED DESCRIPTION OF THE INVENTION

As mentioned previously, in any sequential color display system, it is the object to display and view the color components of a desired image sequentially over time. In a confidential viewing system utilizing sequential color encoding, the color components of a fundamental image are time-multiplexed with corresponding masking color components in accordance with a desired sequencing pattern. This renders the fundamental image substantially indecipherable to the naked eye, which can then be viewed only through the use of specialized eyewear.

One basic sequencing pattern for such a confidential viewing system is shown in the following table:

TABLE I

Frame

| | n | n₊₁ | n₊₂ | n₊₃ | n₊₄ | n₊₅ |
|---|---|---|---|---|---|---|
| Red | F | I | I | F | I | I |
| Green | I | F | I | I | F | I |
| Blue | I | I | F | I | I | F |

If an overlay image is incorporated, the basic sequencing pattern will include overlay color components as follows:

TABLE II

Frame

| | n | n₊₁ | n₊₂ | n₊₃ | n₊₄ | n₊₅ |
|---|---|---|---|---|---|---|
| Red | F | O | I | F | O | I |
| Green | I | F | O | I | F | O |
| Blue | O | I | F | O | I | F |

Tables I and II above show two (2) complete cycles of a basic sequencing pattern for a confidential viewing system utilizing sequential color encoding. The “F” represents fundamental color components; the “I” represents inverse or masking color components that are time-multiplexed with the fundamental color components; and the “O” in Table II represents optional overlay color components.

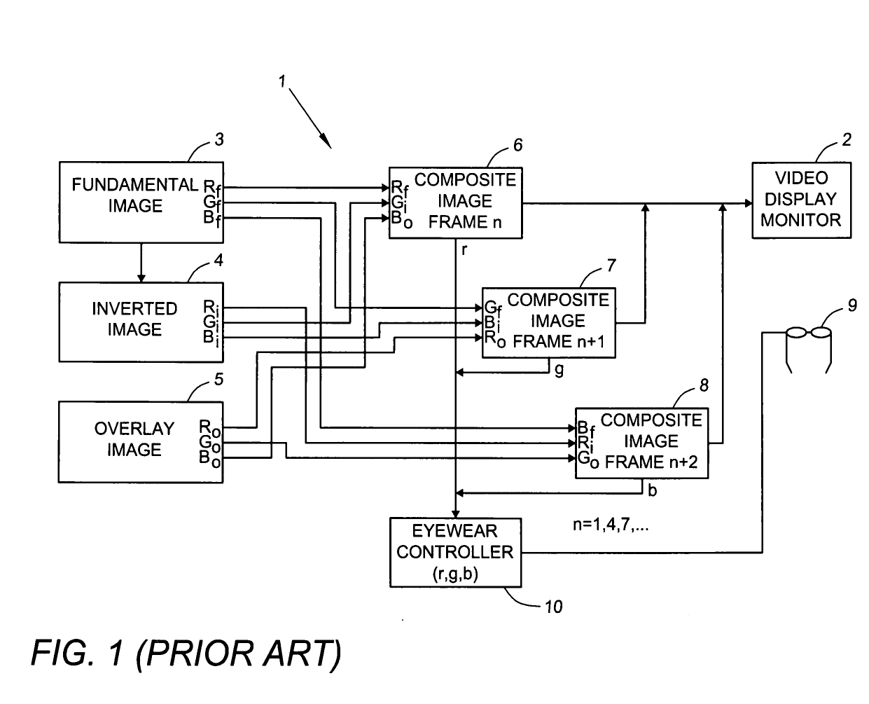

Illustration of such a confidential viewing system is shown generally in the block diagram of FIG. 1, labeled “Prior Art,” where multiple images generated within a computer system 1 are color separated, and then displayed and viewed sequentially over time on a computer display 2. Typically, the desired image to be viewed, noted as the “fundamental image,” is generated by an image signal generator, such as a video display adapter, within the computer. This fundamental image, composed of red, green and blue color components R_{f}, G_{f} and B_{f}, is shown in block 3. The corresponding masking image, preferably an “inverse image”, is derived from the fundamental image and shown in block 4. An optional intentionally misleading image, designated as the “overlay image,” is shown in block 5. Various color components of each image are sequentially combined with sequence controlling logic within the computer system 1 and displayed as a function of frame number in accordance with a desired sequencing pattern.

In FIG. 1, the composite image of the first frame (n=1), as shown in block 6, contains color components from all three images. The red components “R_{f}” are from the fundamental image; the green components “Gᵢ” are from the inverse image; and the blue components “Bₒ” are those of the overlay image. With each successive frame, the frame number increases and the color components are obtained from the three different images, as shown by the arrows leading into blocks 6, 7 and 8. At any one time, only one fundamental color component is present in the composite image displayed on the video monitor 2.

In the resulting composite image, the fundamental image is canceled by the inverse image, leaving only the overlay image visible. However, since all of the fundamental color components of the fundamental image are still present over time, properly synchronized eyewear 9, controlled by the sequencing logic of eyewear controller 10, can be utilized to extract the image.

Performance of such confidential viewing systems, particularly those utilizing LCD technology, is limited by the fact that the present state of the art does not allow for fast enough switching of display elements to avoid what is known as display frame crosstalk. Crosstalk occurs when the contents of one display frame interferes with another. This is particularly significant in LCD displays, where pixels do not decay as in conventional CRT displays.

It appears from FIG. 1 and the above tables that all pixels during each frame of the display change in synchronization. In reality, however, the pixels of most displays, including LCD displays, change from top to bottom in much the same manner as a traditional cathode ray tube (“CRT”) display. This is in part because of the way the displays are addressed. The analog video signals which contain the frame by frame video information are in a traditional CRT format containing both horizontal trace and vertical synchronization signals. Newer LCD inputs are designed to be compatible, so end up updating the display pixels in like fashion; that is, row by row, from top to bottom, until the entire frame is updated. After the last row is complete, the vertical synch pulse signals the update to return to the top left and the process starts over again. In this format, pixels from the entire frame are not updated simultaneously.

This leads to timing errors that cause display frame crosstalk when viewing the display through the specialized color-filtering eyewear 9. The eyewear 9 is capable of changing color states very rapidly in synchronization with the display's vertical refresh rate. However, even though the eyewear has changed colors, not all of the pixels of the display are yet updated. For instance, the eyewear may have changed red to view the fundamental red color components of a particular frame. However, since the pixels update in a sequential fashion row by row from top to bottom, color components from the previous frame will still be present. This is particularly true with respect to LCD displays, where the pixels do not decay, and in fact do not change at all unless required to do so in the next frame update. The previous frame may contain other fundamental or inverse color components, or components from an overlay image.

This problem of display frame crosstalk can be substantially reduced or eliminated by sequencing pixel data with the use of “setup frames.” Setup frames provide for advance updating of each color component intended for viewing immediately prior to viewing that component. As such, the next color component to be viewed is updated during the next preceding display frame, while the previous color component in the sequence of colors is still being viewed. Table III below shows one complete cycle of the most basic sequencing pattern for confidential viewing utilizing setup frames.

TABLE III

Frame

| | n | n₊₁ | n₊₂ | n₊₃ | n₊₄ | n₊₅ |
|---|---|---|---|---|---|---|
| Red | F | F | I | I | I | S |
| Green | I | S | F | F | I | I |
| Blue | I | I | I | S | F | F |

Here again, the “F” represents fundamental color components, and the “I” represents inverse or masking color components that are time-multiplexed with the fundamental color components. The “S” represents the “setup” color components for each of the respective colors.

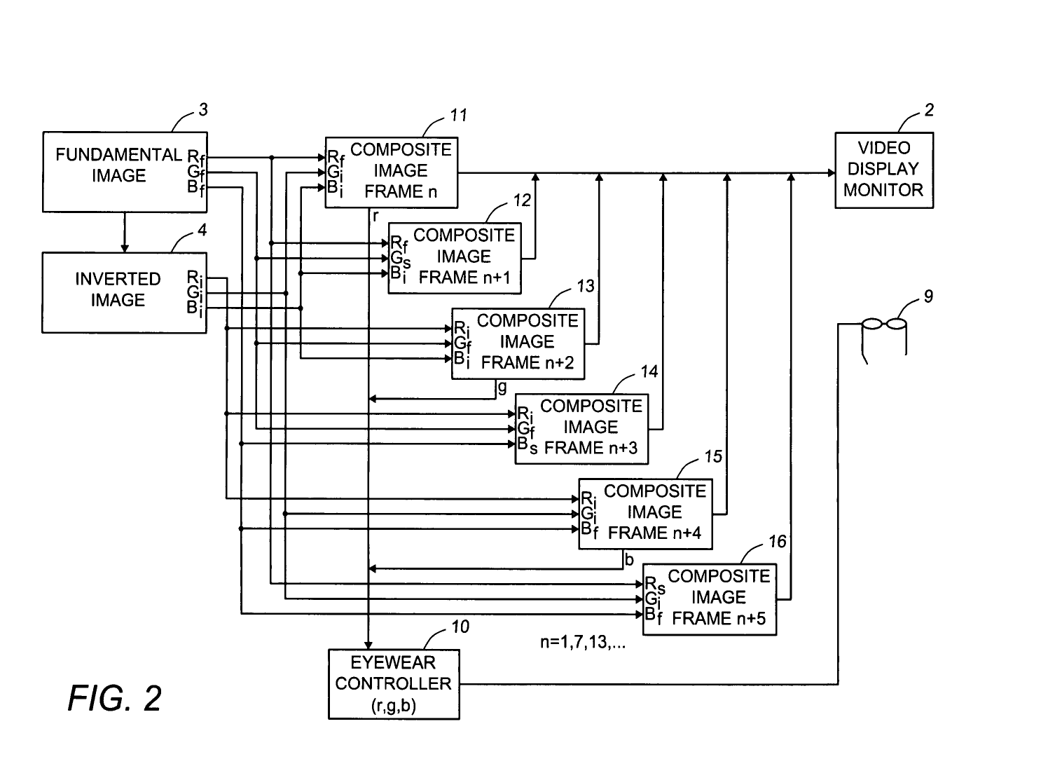

This same sequencing pattern is illustrated in the system block diagram of FIG. 2, where blocks 11-16 represent, respectfully, display frames n₊₁ thru n₊₅ of Table III above. From FIG. 2, it is seen that the sequencing control logic of computer system 1 now generates a cyclical display sequence composed of six (6) separate display frames (blocks 11-16). The composite image of the first frame (n=1), designated as block 11, is composed of the red fundamental color component R_{f} and the green and blue inverse color components, Gᵢ and Bᵢ. In the next frame (n₊₁), with the eyewear 9 still indexed by controller 10 for viewing “red” color components, the green setup color components Gₛ, taken from the fundamental image 3, are initiated and begin updating for subsequent viewing of the green fundamental color components G_{f} in frames “n₊₂” and “n₊₃.” Since the eyeglasses 9 will not yet have switched from red to green, the viewer will see only the intended red fundamental color components R_{f} at this time.

In the next frame (n₊₂), which is designated as block 13 in FIG. 2, eyewear controller 10 causes eyeglasses 9 to very quickly (less than 1 millisecond) change to the color green. However, since the green color components of the fundamental image on the display will have already changed as a result of the use of the green set-up color components Gₛ in the previous frame, crosstalk between display frame data is avoided. Then, while continuing to view the green fundamental color components, in frame “n₊₃” (block 14), the blue setup color components Bₛ are initiated to update the blue fundamental color components for viewing in subsequent frames “n₊₄” and “n₊₅” (blocks 15 and 16). Again, by the time controller 10 converts the eyeglasses 9 to a blue filter in frame n₊₄, the display will have completed its update for the blue color components, thus avoiding display frame crosstalk. This same process of introducing a “setup frame” is repeated in frame “n₊₅” for updating the following red fundamental color components, as the sequencing pattern continues. In this way, over time, each color component is continually updated before the color of the glasses is switched.

Since two (2) out of every six (6) display frames for each color contain fundamental color components, this example shows 1:3 duty cycle or “brightness” for the fundamental color components, without an overlay frame. Because the specialized eyewear permits viewing only of a single color component at any given time, the viewer cannot see the color component being updated during the setup frame. By initiating the update of the display in advance of viewing the next color component, upon switching to the next display frame, the color component then intended to be viewed will already have been activated at all pixel locations. The setup frame assures that the fundamental image is completely updated before the eyeglasses change color states in the subsequent frame, thus eliminating crosstalk.

In confidential viewing systems where the masking image is the “inverse” of the fundamental image, as above, all display frames containing fundamental color components “F” should preferably be cancelled by an equal number of display frames containing inverse color components “I” so as to maintain secure viewing. For this reason, as shown in Table III above, an additional “inverse” frame is used for each color to cancel the “setup” frame, which is essentially a fundamental frame in transition that is not viewed. Since the two consecutive fundamental components “F” for each color are the same, the overall frame rate is slowed down by a factor of six (6). While this is not problematic for static images, it can pose more of a problem for moving images. However, since most typical motion pictures are filmed at a much slower rate (approximately 30 Hz) in comparison to the refresh rate of most standard computer displays, images from a motion picture are generally repeated in multiple display frames, thereby lessening the problem. Also, since the eye will still see one new color component every other frame, this reduces the effective frame rate by only a factor of two (2).

It is also possible to utilize setup frames in confidential viewing systems that incorporate overlay images. The following table shows one complete cycle of a basic sequencing pattern with an overlay image incorporated therein.

TABLE IV

| | Frame | | | | | | | | |
|---|---|---|---|---|---|---|---|---|---|
| | n | n₊₁ | n₊₂ | n₊₃ | n₊₄ | n₊₅ | n₊₆ | n₊₇ | n₊₈ |
| Red | F | F | F | I | I | I | I | O | S |
| Green | I | O | S | F | F | F | I | I | I |
| Blue | I | I | I | I | O | S | F | F | F |

Once again, the “F” represents fundamental color components; the “I” represents inverse or masking color components that are time-multiplexed with the fundamental color components; the “O” represents overlay color components; and the “S” represents the setup color components for each of the respective colors. As in the previous embodiment, setup frames are incorporated and function in the identical manner to update each fundamental color component immediately prior to viewing the same. Since each setup frame occurs during the last display frame of the previous color being viewed, and the specialized eyewear permits viewing only of a single fundamental color component at any given time, the viewer cannot see the color component being updated during the setup frame. Like the inverse (masking) frames, the overlay color components do not require a setup frame, as they are intended to be viewed only by the naked eye, and are therefore blocked from view when wearing the eyeglasses.

With the addition of the color components “O” corresponding to the overlay image, the overall sequencing pattern is expanded. Nevertheless, three (3) out of every nine (9) display frames for each color still contain fundamental color components “F,” so this example again demonstrates a 1:3 duty cycle for the fundamental color components, but also adds a 1:9 duty cycle for an overlay image.

The duty or brightness of the overlay can be expanded as desired. For example, the following table demonstrates a 1:3 fundamental duty cycle with 1:5 duty cycle for the overlay image.

TABLE V

| | Frame | | | | | | | | | | | | | | |
|---|---|---|---|---|---|---|---|---|---|---|---|---|---|---|---|
| | n | n₊₁ | n₊₂ | n₊₃ | n₊₄ | n₊₅ | n₊₆ | n₊₇ | n₊₈ | n₊₉ | n₊₁₀ | n₊₁₁ | n₊₁₂ | n₊₁₃ | n₊₁₄ |
| Red | F | F | F | F | F | I | I | I | I | I | I | O | O | O | S |
| Green | I | O | O | O | S | F | F | F | F | F | I | I | I | I | I |
| Blue | I | I | I | I | I | I | O | O | O | S | F | F | F | F | F |

The tradeoff for increasing the duty cycle of the overlay is speed. As the number of frames per cycle containing overlay components increase, so do the number of overall display frames in the sequence. This limits the video response for moving images. Since the above sequence is 15 frames long, only 4 complete frame cycles per second can be displayed in a typical 60 Hz system. Since the eyeglasses only switch between colors 12 times per second, some color flicker may become visible. Flicker to those not wearing the eyewear can become much worse, however, since the individual color intensities may vary greatly from fundamental to inverse.

Dynamic range compression can be utilized to improve the speed of the sequence. If, for example, the dynamic range of the fundamental image (and consequently the fundamental color components) is reduced 2: 1, then the dynamic range of each corresponding setup color component will also be reduced by 2:1. The number of inverse frames in the basic sequencing pattern can now be cut in half, as shown in the following table.

TABLE VI

Frame

| | n | n₊₁ | n₊₂ |
|---|---|---|---|
| Red | F_{1/2} | I | S_{1/2} |
| Green | S_{1/2} | F_{1/2} | I |
| Blue | I | S_{1/2} | F_{1/2} |

In this example, “F_{1/2}” represents the 2:1 dynamically compressed fundamental color components for each color, and “S_{1/2}” represents the corresponding setup color component for each. Since the dynamic range of all fundamental and setup color components have been cut in half, just one standard inverse frame may be used to cancel or mask both the fundamental and setup frames for each color in the sequence. Each fundamental color component can now be updated every 3rd frame.

3D Viewing

As noted previously, in most 3D viewing systems utilizing image-filtering eyewear and a display, LCD shutter glasses are used to block the left components of an image from the right eye, and the right components from the left eye. Separate image perspectives on the display, which alternate in synchronization with the glasses, are intended for either the right or left eye only. This technique is known as “field sequential,” and can be effectively implemented using LCD shutters and a CRT display. Unfortunately, when slower LCD displays are used, the LCD shutters introduce substantial flicker, and crosstalk becomes a huge problem. With an LCD display, as the lenses switch from left to right, and right to left, each eye is allowed to view a substantial portion of the previous frame.

Color sequential display systems similar to that used in confidential viewing systems have been proposed in the past as a way of eliminating the irritating eye flicker found in field sequential systems. In such systems, color sequential encoding is employed separately and independently for the left and right eye image perspectives. However, problems with display frame crosstalk have heretofore limited the use of such systems to CRT displays, where the image decays substantially before the start of the next frame. With an LCD display, as the eyeglass lenses switch colors from left to right, remains of the previous image are still visible. This is shown in the following three-color coding sequence where, through the use of synchronized color-filtering eyewear, each eye is intended to see the following red (R), green (G) and blue (B) color components of a different image perspective, where the subscripts denote either the left or right perspective:

TABLE VII

Frame

| | ⁿ | n₊₁ | n₊₂ |
|---|---|---|---|
| Left | R_{L} | G_{L} | B_{L} |
| Right | G_{R} | B_{R} | R_{R} |

Ideally, each eye sees only one color component at a time, but because of crosstalk effects, the residual image from the previous frame will still be visible. For instance, as the left eye switches from red to green in the second frame (n₊₁) above, due to crosstalk, most of the green image will still be intended for the right eye from the previous frame. Thus, during this time, the left eye sees much of the green components intended only for the right eye. Not until the end of the frame, when the entire screen has been updated, will all of the green pixels be intended for the left eye only.

Setup frame sequencing can also be used to implement a 3D viewing system using sequential color separation. Since there are three colors, but just two eyes, only two color components are viewed at one time, so setup frames can be used to avoid image crosstalk by continually updating each color component during the display frame in which it is not being viewed. This can be seen in the following sequencing table which demonstrates how each color component is continually updated using a setup frame immediately prior to being viewed by either the right or left eye:

TABLE VIII

Frame

| | n | n₊₁ | n₊₂ | n₊₃ | n₊₄ | n₊₅ |
|---|---|---|---|---|---|---|
| Red | L | L | S | R | R | S |
| Green | R | S | L | L | S | R |
| Blue | S | R | R | S | L | L |

For each color component, the “L” represents the left eye image perspective; the “R” represents the right eye image perspective; and the “S” indicates the setup frame, which in this case is a transition from left to right or right to left perspective image within the same color.

Considering this now from the eyes of a viewer wearing special synchronized color-filtering eyewear, the left and right eye now view the following:

TABLE IX

Frame

| | n | n₊₁ | n₊₂ | n₊₃ | n₊₄ | n₊₅ |
|---|---|---|---|---|---|---|
| Left | R | R | G | G | B | B |
| Right | G | B | B | R | R | G |

For 3D viewing, each eye is intended to view a desired object through synchronized color-filtering eyewear from a different perspective. Therefore, each eye's viewable image is independent from the other, and is sequentially color encoded. From Table VIII above, however, it can be seen that during any display frame in which a red, green or blue color component is not being viewed by either the right or left eye through the color-filtering eyewear, it is being updated in advance for viewing by either the right or left eye in the next following display frame.

By way of example, from either Table VIII or IX it can be seen that, during display frame “n,” the left eye sees the red color component of the left perspective image, and the right eye sees the green color component of the right perspective image. The eyeglasses are set to switch in frame n+l to permit viewing of the right eye blue color component, so as shown in Table VIII, the right eye blue color component is initiated and begins updating during the previous display frame “n.” Thus, frame “n” becomes a setup frame for the right eye blue color component. Then, in frame n₊₂, the eyeglasses switch again to permit viewing of the left eye green color component, so as shown in Table VIII, previous frame n₊₁ becomes a setup frame for the left eye green color component. Continuing this sequence eliminates left/right crosstalk in 3D viewing systems, and is completely flicker free.

From the above, it can be seen that through the use of setup frames in the sequencing patterns of color sequential viewing systems, the heretofore problem of display frame crosstalk can be substantially reduced or eliminated. In confidential viewing systems utilizing color sequential encoding, setup frames may be used to update color components of the fundamental image prior to extraction and viewing thereof with synchronized color-filtering eyewear. Likewise, in 3D viewing systems using sequential color encoding for the right and left perspective images, setup frames can also be used to update the sequentially displayed color components for each eye immediately prior to viewing the same. While the above discussion focuses primarily on confidential and 3D viewing systems, it is certainly contemplated that there may be other applications involving sequential color encoding of a display image for which the principles of the present invention will work equally well. It will, of course, be understood that various changes may be made in the form, details, arrangement and proportions of the parts without departing from the scope of the invention which comprises the matter shown and described herein and set forth in the appended claims.

1. A color sequential image display apparatus, comprising:
(a) a display;
(b) an image generator for generating a fundamental image on said display, said fundamental image having a plurality of distinct color components, said plurality of color components having a display sequence characterized in that at least one of said color components is displayed out of time-phase with the remainder of said color components of said fundamental image;
(c) viewing means synchronized with said display for independently viewing each of said color components of said fundamental image sequentially during different display frames; and
(d) a color sequence controller which initiates the display of at least some of said color components prior to viewing such said color components through said viewing means, thereby reducing the effects of display frame crosstalk.

2. The color sequential image display apparatus of claim 1, wherein each of said color components is time-multiplexed with a corresponding masking color component of a masking image which masks said fundamental image from viewing with the naked eye.

3. The color sequential image display apparatus of claim 2, wherein said color components of said fundamental image and said masking color components have a cyclical display sequence determined in accordance with the following table:

| | | | | | | |
|---|---|---|---|---|---|---|
| Red | F | F | I | I | I | S |
| Green | I | S | F | F | I | I |
| Blue | I | I | I | S | F | F |

where “F” represents said color components of said fundamental image corresponding to each of the colors red, green and blue; “I” represents said masking color components corresponding to each of the colors red, green and blue; and “S” represents setup color components corresponding to each of the colors red, green and blue, which are generated by said color sequence controller to initiate the display of each of said color components of said fundamental image prior to viewing thereof through said viewing means.

4. The color sequential image display apparatus of claim 3, wherein each said masking color component is an inverse color component of its said corresponding color component of said fundamental image.

5. The color sequential image display apparatus of claim 2, including an overlay image generator for generating an overlay image with overlay color components on said display, wherein said color components of said fundamental image, said overlay color components and said masking color components having a cyclical display sequence determined in accordance with the following table:

| | | | | | | | | | |
|---|---|---|---|---|---|---|---|---|---|
| Red | F | F | F | I | I | I | I | O | S |
| Green | I | O | S | F | F | F | I | I | I |
| Blue | I | I | I | I | O | S | F | F | F |

where “F” represents said color components of said fundamental image corresponding to each of the colors red, green and blue; “I” represents said masking color components corresponding to each of the colors red, green and blue; “O” represents said overlay color components corresponding to each of the colors red, green and blue; and “S” represents setup color components corresponding to each of the colors red, green and blue, which are generated by said color sequence controller to initiate the display of each of said color components of said fundamental image prior to viewing thereof through said viewing means.

6. The color sequential image display apparatus of claim 2, wherein said color sequence controller is comprised of sequencing logic which generates a setup color component that is added to said display sequence immediately preceding the display of each of said color components of said fundamental image, said setup color component being of the same wavelength as said color component which it immediately precedes.

7. The color sequential image display apparatus of claim 2, wherein said setup color components and said color components of said fundamental image are dynamically compressed.

8. The color sequential image display apparatus of claim 1, wherein said fundamental image is comprised of a left image perspective and a right image perspective, and said viewing means separates said left image perspective for left-eye viewing only and said right image perspective for right-eye viewing only.

9. The color sequential image display apparatus of claim 8, wherein said color components have a cyclical display sequence corresponding to said left and right image perspectives determined in accordance with the following table:

| | | | | | | |
|---|---|---|---|---|---|---|
| Red | L | L | S | R | R | S |
| Green | R | S | L | L | S | R |
| Blue | S | R | R | S | L | L |

where “L” represents said color components for each of the colors red, green and blue corresponding to said left eye image perspective; “R” represents said color components for each of the colors red, green and blue corresponding to said right eye image perspective; and “S” represents setup color components corresponding to each of the colors red, green and blue, which are generated by said color sequence controller to initiate the the display of each of said color components corresponding to said left and right image perspectives prior to viewing thereof through said viewing means.

10. The color sequential image display apparatus of claim 1, wherein each of said color components of said fundamental image is updated by said color sequence controller prior to viewing thereof through said viewing means.

11. The color sequential image display apparatus of claim 10, wherein said color sequence controller updates each of said color components of said fundamental image in said display frame immediately prior to said display frame in which it is to be viewed through said viewing means.

12. The color sequential image display apparatus of claim 1, wherein said color sequence controller is comprised of sequence control logic which generates a setup frame that is added to said display sequence for updating the display of each of said color components of said fundamental image prior to viewing such said color component through said viewing means.

13. In a color sequential image display apparatus having means for displaying and independently viewing each of a plurality of color components of a fundamental image sequentially over time through a synchronized color-filter viewing apparatus, the improvement comprising means for initiating the display of at least some of said color components prior to viewing such said color components through said viewing apparatus, thereby reducing the effects of display frame crosstalk.

14. The color sequential image display apparatus of claim 13, wherein each of said color components of said fundamental image is time-multiplexed with a corresponding masking color component of a masking image which masks said fundamental image from viewing with the naked eye, said color components of said fundamental image and said masking color components having a cyclical display sequence determined in accordance with the following table:

| | | | | | | |
|---|---|---|---|---|---|---|
| Red | F | F | I | I | I | S |
| Green | I | S | F | F | I | I |
| Blue | I | I | I | S | F | F |

where “F” represents said color components of said fundamental image corresponding to each of the colors red, green and blue; “I” represents said masking color components corresponding to each of the colors red, green and blue; and “S” represents setup color components corresponding to each of the colors red, green and blue, which are generated by said means for initiating the display of each of said color components of said fundamental image prior to viewing thereof through said viewing means.

15. The color sequential image display apparatus of claim 13, wherein:
(a) said plurality of color components of said fundamental image have a display sequence characterized in that at least one of said color components is displayed out of time-phase with the remainder of said color components of said fundamental image; and
(b) said means for initiating the display of at least some of said color components prior to viewing such said color components is comprised of a setup color component that is added to said display sequence immediately preceding the display of each of said color components of said fundamental image, said setup color component being of the same wavelength as said color component which it immediately precedes.

16. A method for reducing display frame crosstalk in a color sequential image display apparatus, comprising the steps of:
(a) displaying a plurality of color components of a fundamental image sequentially over time on a display apparatus, wherein said plurality of color components have a display sequence characterized in that at least one of said color components is always displayed during a different display frame of said display apparatus than the remainder of said color components of said fundamental image;
(b) independently viewing each of said color components of said fundamental image sequentially over time during different display frames of said display apparatus in synchronization with said color component display sequence; and
(c) initiating the display of at least some of said color components of said fundamental image on said display prior to independently viewing such said color components.

17. The method for reducing display frame crosstalk set forth in claim 16, wherein said step of initiating the display of at least some of said color components of said fundamental image includes the introduction of a setup display frame in said display sequence immediately prior to said display frame in which each of said plurality of color components of said fundamental image is to be viewed, wherein the display of said color component to be viewed is initiated.

18. The method for reducing display frame crosstalk set forth in claim 17, wherein said step of initiating the display of at least some of said color components of said fundamental image includes completely updating said color component to be next viewed on said display during said setup display frame.

19. The method for reducing display frame crosstalk set forth in claim 16, wherein said step of displaying a plurality of color components of a fundamental image sequentially over time includes time-multiplexing said color components of said fundamental image with masking color components of a masking image so as to render said fundamental image indecipherable to the naked eye.

20. The method for reducing display frame crosstalk set forth in claim 19, wherein said step of initiating the display of at least some of said color components of said fundamental image includes modifying said display sequence in accordance with the following display cycle:

| | | | | | | |
|---|---|---|---|---|---|---|
| Red | F | F | I | I | I | S |
| Green | I | S | F | F | I | I |
| Blue | I | I | I | S | F | F |

where “F” represents said color components of said fundamental image corresponding to each of the colors red, green and blue; “I” represents said masking color components corresponding to each of the colors red, green and blue; and “S” represents setup color components corresponding to each of the colors red, green and blue, which are introduced in said display sequence as a means for initiating the display of each of said color components of said fundamental image prior to viewing the same.
